(19) United States
(12) Patent Application Publication
(10) Pub. No.: US 2011/0199252 A1
(43) Pub. Date: Aug. 18, 2011

(54) SENSOR DEVICE HAVING A VARIABLE AZIMUTHAL DETECTION RANGE FOR A MOTOR VEHICLE

(76) Inventors: Michael Klar, Magstadt (DE); Thomas Binzer, Stuttgart (DE); Klaus-Dieter Miosga, Backnang (DE); Oliver Brueggemann, Oelbronn-Duerrn (DE); Joachim Hauk, Renningen-Malmsheim (DE); Elisabeth Hauk, Renningen-Malmsheim (DE); Rahel Hauk, Renningen-Malmsheim (DE); Manuel Hauk, Renningen-Malmsheim (DE); Juergen Seiz, Welzheim (DE)

(21) Appl. No.: 12/599,690

(22) PCT Filed: Apr. 18, 2008
(86) PCT No.: PCT/EP2008/054700

§ 371 Date: Oct. 27, 2010

(30) Foreign Application Priority Data
Jun. 19, 2007 (DE) 102007027975.4

(51) Int. Cl. B60K 31/00; H01Q 19/08; H01Q 1/32; G01S 13/02

(52) U.S. Cl. 342/70; 343/753; 343/711

(57) ABSTRACT

A sensor device, in particular a radar sensor device for a motor vehicle, in whose beam path at least one antenna exciter and at least one lens are situated, in which at least one diaphragm having a variable azimuthal opening width for realizing a variable azimuthal detection range of the radar sensor device is situated in the beam path between the at least one antenna exciter and the at least one lens.

### FIELD OF THE INVENTION

The present invention relates to a sensor device, in particular a radar sensor device for a motor vehicle.

### BACKGROUND INFORMATION

Sensor devices are used as distance sensors in cruise control systems for motor vehicles, by which the speed of the motor vehicle is able to be regulated to a driver-selected desired speed. With the aid of the distance sensors, e.g., radar sensors, lidar sensors or the like, the distance to a vehicle driving in front is able to be measured. The speed regulation is then modified so as to maintain a specified, which may be speed-dependent, distance to the vehicle driving ahead and selected as target object. Such systems are also referred to as adaptive cruise control systems (ACC). Adaptive speed control devices of this type are described in the publication of Robert Bosch GmbH, “Adaptive Fahrgeschwindigkeitsregelung ACC, Gelbe Reihe, Ausgabe 2002, Technische Unterrichtung” (Adaptive Speed Control ACC, Yellow Series, 2002 Edition, Technical Instruction). A generic sensor device is shown there as well.

Today, sensor systems for such systems are often based on the radar principle. Typical representatives of radar systems operate in the range of 77 GHz or also in the range of 24 GHz. The current systems operate on the basis of relatively rigid system characteristics. For example, no change in the antenna characteristic is possible during operation of such a radar device. Other parameters are fixed as well, so that, for example, the power characteristics cannot be adapted when driving on highways, rural roads or in the city. Furthermore, radar devices for adaptive cruise control systems typically have a relatively narrow directional effect focused in the azimuth. Such LRR (long range radar) sensors are built for detecting and measuring vehicles and other objects within the visual range, at ranges of up to 200 m or more at a rather narrow angular visual range or detection range of <+/−10°. However, for adaptive cruise control systems and corresponding PSS (predictive safety systems) functions, such azimuthal angular visual ranges often are insufficient.

For a sensor device for a vehicle it is known from the German patent DE 10 2004 044 067 A1 to use an adaptive design for the antenna characteristic of a mono pulse antenna for the directional transmission and reception of electromagnetic signals, using an electronics device for controlling the mono pulse antenna and for evaluating received signals of the mono pulse antenna. For this purpose, the mono pulse antenna may be controllable by the electronics device using DBF (digital beam forming).

### SUMMARY OF THE INVENTION

The sensor device according to the present invention, in particular a radar device for a motor vehicle, in whose beam path at least one antenna exciter and at least one lens are disposed, at least one diaphragm having a variable azimuthal opening width for realizing a variable azimuthal detection range of the sensor device being situated in the beam path between the at least one antenna exciter and the at least one lens, has the advantage that different azimuthal angular visual ranges, in particular also a narrow long-range detection range (long range radar—LRR) and a closer wide-angle detection range (mid-range radar—MRR) are able to be covered with the aid of the sensor device. In an advantageous manner, the visual range is able to be switched by extending the at least one diaphragm between the antenna exciter or the exciter and the lens or the radar lens or the ray-bundling element, which diaphragm is mechanically or electrically variable in its horizontal or azimuthal opening width.

Thus, even broader horizontal opening angles in the close range are able to be detected using the sensor device according to the present invention. This adjustment option makes it possible to respond very elegantly, simply and cost-effectively to different specifications regarding the opening angle of the sensor device. In this context it should be noted that because of the beam bundling properties of the lens, a large opening width of the diaphragm leads to a narrower visual field, and a small opening width leads to a broader visual field of the sensor device according to the present invention. Moreover, it is conceivable to increase the measuring resolution of the sensor device by taking different antenna characteristics into account in a plurality of measurements using different diaphragm opening widths.

A plurality of developments, possibly also in combination, is conceivable for the diaphragm in the sensor device according to the present invention.

According to the present invention, the at least one diaphragm may have a plurality of cover elements, which form a louver blind, in particular, and are able to be folded into the beam path.

These measures produce a mechanically simple diaphragm, which is able to be switched at high speed as a louver blind.

Furthermore, the at least one diaphragm may be provided with one or a plurality of cover elements, which are able to be slipped into the beam path in the way of a roller blind.

It is advantageous if the at least one diaphragm has polarizing grating elements having a specified polarization direction in the beam path, the antenna exciter emitting correspondingly polarized radiation in order to realize a variable azimuthal opening width, which radiation passes through the polarizing grating elements or whose passage is impeded thereby. Thus, the diaphragm effect is able to be achieved in a simple manner through polarization. For instance, polarizing gratings having a polarization of less than +45° may be provided in the beam path.

If the antenna exciter now likewise emits +45° polarized radiation, then the passage of the radiation produces a correspondingly narrower visual field of the sensor device according to the present invention, since bundling of the radar beam is aided by the lens. On the other hand, if the antenna exciter transmits −45° polarized radiation, then this radiation is blocked accordingly by the polarizing grating elements and is unable to reach the lens. Due to the ray-bundling characteristics of the lens, this results in a considerably wider beam and thus in a broader azimuthal detection range of the sensor device according to the present invention.

According to the present invention, the at least one diaphragm may also have damping elements, which are made of a material having a transparency to radiation that is able to be controlled by an electric or magnetic field, in particular.

Moreover, it is advantageous if the at least one lens is provided with the at least one diaphragm. The diaphragm may be situated on the lens for that purpose. For instance, the damping elements or the polarizing grating elements may be applied on the lens in appropriate manner.

Claim 7 relates to an adaptive cruise control device for motor vehicles. A motor vehicle is indicated in Claim 8.

Exemplary embodiments of the present invention are schematically represented below in view of the drawing.

### BRIEF DESCRIPTION OF THE DRAWINGS

FIG. 1 shows a schematic illustration of the essential components of an ACC system or an adaptive cruise control device in a motor vehicle having a sensor device according to the present invention.

FIG. 2 shows a basic representation of the sensor device according to the present invention in a first specific development including foldable cover elements.

FIG. 3 shows a basic representation of the sensor device according to the present invention in a second specific development, including foldable cover elements, which form a louver blind.

FIG. 4 shows a basic representation of the sensor device according to the present invention in a third specific development, including a plurality of cover elements, which are able to be slipped into the beam path in the manner of a louver blind.

FIG. 5 shows a basic representation of the sensor device according to the present invention in a fourth specific development, having a diaphragm, which has polarizing grating elements.

FIG. 6 shows a basic representation of the sensor device according to the present invention in a fifth specific development, having a diaphragm, which is provided with damping elements.

FIG. 7 shows an antenna diagram of a sensor device without diaphragm.

FIG. 8 shows an antenna diagram of the sensor device according to the present invention, having a diaphragm which has an opening width of 30 mm.

FIG. 9 shows an antenna diagram of the sensor device according to the present invention, having a diaphragm which has an opening width of 10 mm.

### DETAILED DESCRIPTION

A motor vehicle 10, shown in a greatly simplified manner in FIG. 1 and equipped with an ACC system or an adaptive speed control device 11, has a sensor device or a radar sensor device 12 according to the present invention as distance sensor, which is mounted on the front section of motor vehicle 10, and in whose housing an ACC control unit 14 is accommodated as well. ACC control unit 14 is connected via a data bus 16 (CAN, MOST or the like) to an electronic drive control unit 18, a brake system control unit 20, and an HMI control unit 22 of a human/machine interface. With the aid of a radar beam, radar sensor device 12 measures the distances, relative speeds and azimuth angles of objects that are situated in front of the vehicle and reflect radar waves.

The raw radar data received at regular time intervals, e.g. every 10 ms, are evaluated in ACC control unit 14 in order to identify and track individual objects, and particularly in order to detect an immediately preceding vehicle traveling in one's own lane, and to select it as target object. Via commands to drive control unit 18 and brake system control unit 20, ACC control unit 14 as the device for determining the required acceleration and deceleration, regulates the speed of vehicle 10. If no preceding vehicle is located, ACC control unit 14 regulates the speed of motor vehicle 10 to a driver-selected desired speed. If, however, a preceding vehicle whose speed is slower than that of the own vehicle has been recorded as target object, then the speed of motor vehicle 10 is regulated so as to maintain an appropriate distance from the preceding vehicle.

Functionally equivalent elements in FIGS. 1 through 6 have been provided with matching reference numerals. Of course, the specific developments of diaphragm 30a through 30e may also be combined in additional exemplary embodiments that are not illustrated.

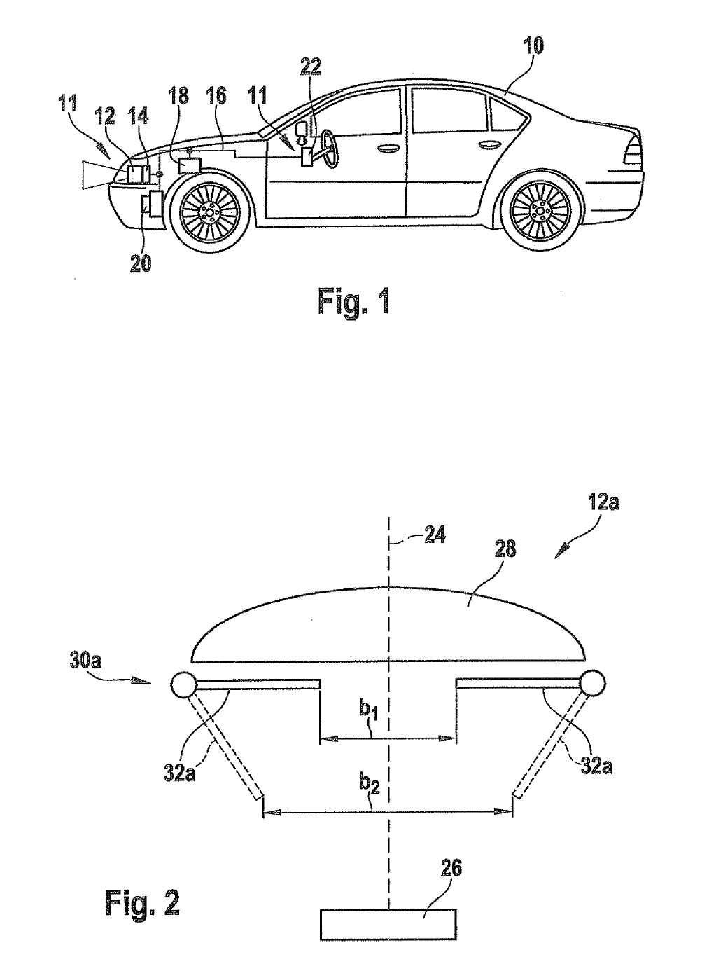

FIG. 2 shows a first specific embodiment of a radar sensor device 12a according to the present invention for motor vehicle 10, in whose beam path 24, which is sketched as main beam of the radar waves or as optical axis in FIGS. 2 through 6, a diaphragm 30a having a variable azimuthal opening width b₁, b₂ for realizing a variable azimuthal detection range of radar sensor device 12a is situated between an antenna exciter 26 and a beam-forming element developed as lens 28. It is therefore possible to cover different azimuthal angular visual ranges, in particular a narrow, long-range detection range, and a closer detection range having a wide angle, using only one radar sensor device 12a.

Diaphragm 30a has cover elements 32a, which are able to be folded into beam path 24. When cover elements 32a are extended into beam path 24 (indicated as a solid line), then an azimuthal opening width b₁ comes about, which results in a broad azimuthal detection range of radar sensor device 12a due to the beam-bundling properties of lens 28. In contrast, when cover elements 32a are folded out into beam path 24 (indicated by dashed lines), a considerably greater azimuthal opening width b₂ comes about, thereby providing a narrower visual field of radar sensor device 12a.

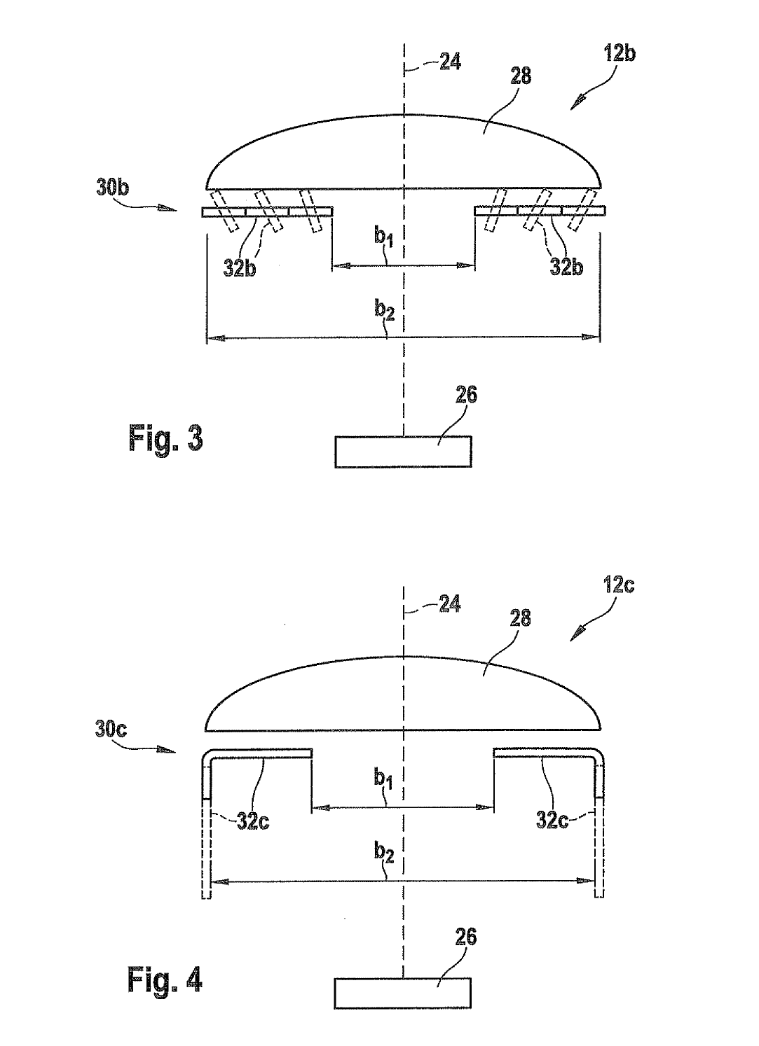

FIG. 3 shows a second specific embodiment of a radar sensor device 12b according to the present invention, in which cover elements 32b of a diaphragm 30b form a louver blind. When retracted into beam path 24, cover elements 32b are situated at least approximately perpendicular to the main radiation direction or the optical axis and result in an azimuthal opening width b₁ of diaphragm 30b. When cover elements 32b are unfolded (dashed lines), cover elements 32b are situated essentially in parallel with the main radiation direction, and an azimuthal opening width b₂ results.

FIG. 4 shows a third specific embodiment of a radar sensor device 12c according to the present invention. A diaphragm 30c has two cover elements 32c, which are able to be slipped into beam path 24 in the form of a roller blind. When slipped into beam path 24, an azimuthal opening width b₁ results, while when cover elements 32c are in the retracted state, an azimuthal opening width b₂ comes about. Azimuthal opening widths b₁, b₂ are shown only exemplarily in FIGS. 2 through 6. Other opening widths are conceivable as well.

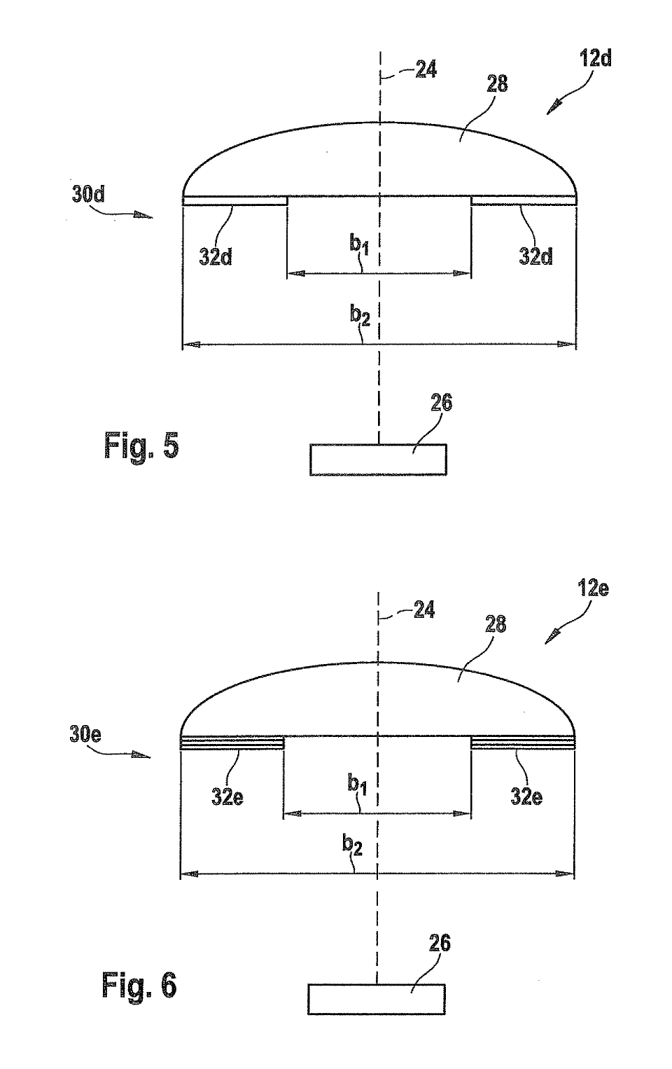

FIG. 5 shows a fourth specific embodiment of a radar sensor device 12d according to the present invention, in which a diaphragm 30d is situated in beam path 24. Diaphragm 30d may be situated on lens 28 and has polarizing grating elements 32d with a specified polarization direction of less than +45°. To realize a variable azimuthal opening width b₁, b₂, antenna exciter 26 emits correspondingly polarized radiation, which passes through polarizing grating elements 32d (opening width b₂, antenna exciter 26 being polarized at +45°), or it is blocked thereby (opening width b₁, antenna exciter 26 being polarized at −45°). This likewise produces different detection ranges for radar sensor device 12d, due to the different opening widths b₁, b₂.

FIG. 6 shows a fifth specific embodiment of a radar sensor device 12e according to the present invention, a diaphragm 30e having damping elements 32e, which are made of a material having a transparency to radiation that is controllable with the aid of an electric or magnetic field. Damping elements 32e correspondingly dampen the radar radiation generated by antenna exciter 26, in order to obtain an opening width b₁ of diaphragm 30e, or they may be switched to transmitting in order to obtain an opening width b₂ and thus bring about the corresponding detection range of radar sensor device 12e. As illustrated in FIG. 6, damping elements 32e may be positioned on lens 28 analogously to polarizing grating elements 32d from FIG. 5. Of course, other approaches are conceivable here as well.

In the exemplary embodiments according to FIGS. 2 through 6, the shapes of diaphragms 30a through 30e are adapted to the shape of lens 28.

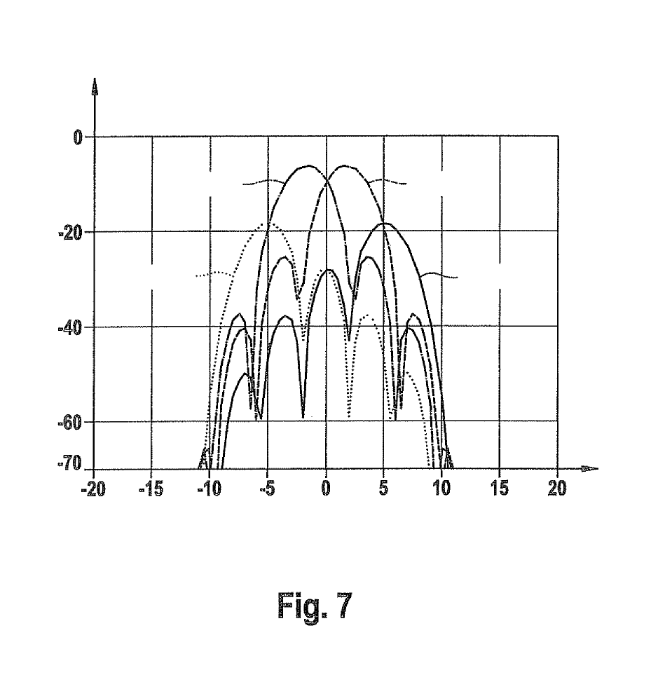

FIGS. 7, 8 and 9 show antenna diagrams or azimuth angle diagrams of horizontal sections of four radar beams—beam 1 through beam 4—, which represent the detection range of a radar sensor device according to the related art and of the radar sensor devices 12, 12a through 12e according to the present invention as a sequence of the effective azimuthal opening widths of diaphragms 30a through 30e.

The azimuth angle is plotted horizontally, and the level in decibels is plotted vertically.

FIG. 7 shows the detection range of a radar sensor device according to the related art, without diaphragm.

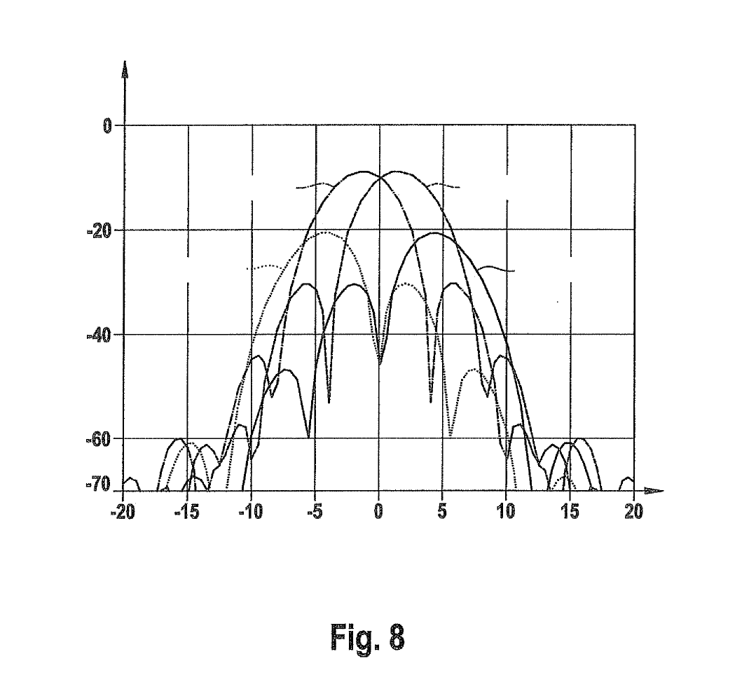

In contrast, FIG. 8 shows the detection range of a radar sensor device 12, 12a through 12e of a radar sensor device according to the present invention, at a 30 mm opening width of diaphragm 30a through 30e.

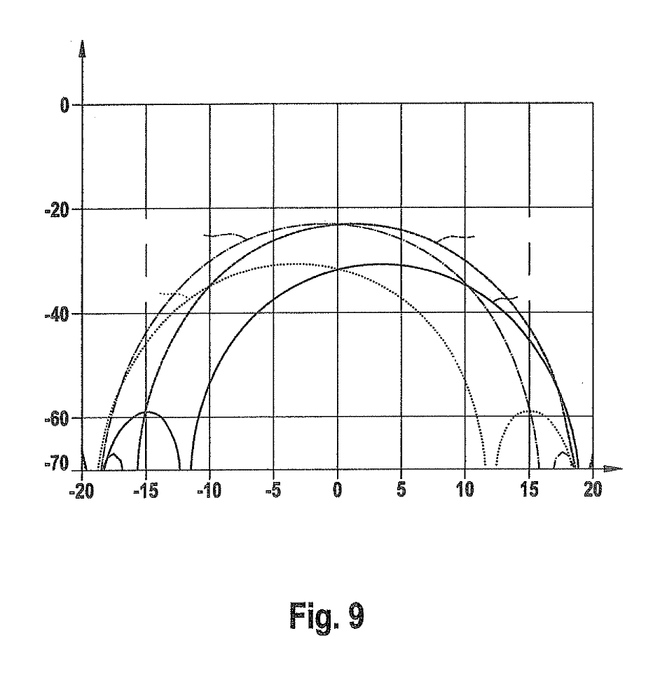

In analogous manner, FIG. 9 shows a detection range at a 10 mm opening width of diaphragm 30a through 30e.

The different radar beams, beam 1 through beam 4, show different reception field strengths/powers at different azimuth angles. This makes it conceivable to increase the measuring resolution of radar sensor devices 12, 12a through 12e by taking different antenna characteristics into account in a plurality of measurements (e.g., at ten measurements per second, for instance), in that a switch to different opening widths b₁, b₂ of diaphragms 30a through 30e takes place between the measurements.

1-8. (canceled)

9. A radar sensor device for a motor vehicle, comprising:
at least one antenna exciter;
at least one lens, wherein the at least one antenna exciter and the at least one lens are disposed in a beam path; and
at least one diaphragm, having a variable azimuthal opening width for realizing a variable azimuthal detection range of the sensor device, is situated in the beam path between the at least one antenna exciter and the at least one lens.

10. The sensor device of claim 9, wherein the at least one diaphragm has a plurality of cover elements, which are able to be extended into the beam path and which form a louver blind.

11. The sensor device of claim 9, wherein the at least one diaphragm has at least one cover element, which is able to be slipped into the beam path in the way of a louver blind.

12. The sensor device of claim 9, wherein the at least one diaphragm has polarizing grating elements having a specified polarization direction in the beam path, the antenna exciter emitting correspondingly polarized radiation for realizing a variable azimuthal opening width, which one of passes through the polarizing grating elements and is blocked by them.

13. The sensor device of claim 9, wherein the at least one diaphragm has damping elements, which are made of a material having a transparency to radiation that is controllable with the aid of an electric or magnetic field.

14. The sensor device of claim 9, wherein the at least one lens is provided with the at least one diaphragm.

15. An adaptive cruise control device for a motor vehicle, comprising:
a radar sensor device for a motor vehicle, including:
at least one antenna exciter;
at least one lens, wherein the at least one antenna exciter and the at least one lens are disposed in a beam path; and
at least one diaphragm, having a variable azimuthal opening width for realizing a variable azimuthal detection range of the sensor device, is situated in the beam path between the at least one antenna exciter and the at least one lens.

16. A motor vehicle, comprising:
a radar sensor device, including:
at least one antenna exciter;
at least one lens, wherein the at least one antenna exciter and the at least one lens are disposed in a beam path; and
at least one diaphragm, having a variable azimuthal opening width for realizing a variable azimuthal detection range of the sensor device, is situated in the beam path between the at least one antenna exciter and the at least one lens.
